(19) United States
(12) Patent Application Publication
(10) Pub. No.: US 2010/0049738 A1
(43) Pub. Date: Feb. 25, 2010

(54) SYSTEM AND METHOD FOR USER INTERFACE DIAGNOSTIC ACTIVITY LOGGING

(76) Inventors: Alok Mathur, Rancho Santa Margarita, CA (US); Man Mohan Garg, Cerritor, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/194,762

(22) Filed: Aug. 20, 2008

(51) Int. Cl. G06F 17/00

(52) U.S. Cl. 707/104.1; 707/100; 707/E17.001

(57) ABSTRACT

The subject application is directed to a system and method for user interface diagnostic activity logging. Parameter data is first acquired corresponding to selected data acquisition parameters. Sequence data is then acquired corresponding to instructions for control of the document processing device via an associated user interface. The sequence is acquired in accordance with the acquired parameter data and stored in an associated storage. Next, event data is acquired corresponding to an occurrence of a selected event by the document processing device. The acquired sequence data is then communicated to an associated administrator upon receipt of event data.

### BACKGROUND OF THE INVENTION

The subject application is directed generally to user interface action logging. The application is particularly suited to strategic capturing of user interface sessions to assist in diagnosing system errors.

User interfaces are used in connection with the operation of many devices. Graphical user interfaces are particularly suited for control of complex devices such as copiers, printers, facsimile devices, or multifunction peripherals having more than one such document processing operation.

A graphical user interface allows for a software-based, easily alterable mechanism for intuitive control of complex functions. For example, a graphical user interface suitably allows for ease of selection of selected document processing functions, as well as finishing options such as paper size, output bin, stapling, hole punching, and the like. A user interface also allows for control of document size, quality, color or black and white, and destination or routing information.

Many operations require a user to enter a sequence of steps on a panel. On occasion, a particular sequence of steps will result in an error or unintended result, which is difficult to replicate when a sequence is complex.

### SUMMARY OF THE INVENTION

In accordance with one embodiment of the subject application, there is provided a system and method for user interface diagnostic activity logging. Parameter data is acquired corresponding to selected data acquisition parameters. Sequence data is also acquired corresponding to instructions for control of the document processing device via an associated user interface, which sequence is acquired in accordance with acquired parameter data. Event data is acquired corresponding to an occurrence of a selected event by the document processing device. The acquired sequence data is stored in a storage and the stored sequence data is communicated to an associated administrator upon receipt of event data.

Still other advantages, aspects and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a user interface diagnostic activity logging system according to one embodiment of the subject application;

FIG. 2 is a block diagram illustrating device hardware for use in the user interface diagnostic activity logging system according to one embodiment of the subject application;

FIG. 3 is a functional diagram illustrating the device for use in the user interface diagnostic activity logging system according to one embodiment of the subject application;

FIG. 4 is a block diagram illustrating controller hardware for use in the user interface diagnostic activity logging system according to one embodiment of the subject application;

FIG. 5 is a functional diagram illustrating the controller for use in the user interface diagnostic activity logging system according to one embodiment of the subject application;

FIG. 6 is a functional diagram illustrating a workstation for use in the user interface diagnostic activity logging system according to one embodiment of the subject application;

FIG. 7 is a block diagram illustrating the user interface diagnostic activity logging system according to one embodiment of the subject application;

FIG. 8 is a functional diagram illustrating the user interface diagnostic activity logging system according to one embodiment of the subject application;

FIG. 9 is a flowchart illustrating a user interface diagnostic activity logging method according to one embodiment of the subject application; and

FIG. 10 is a flowchart illustrating a user interface diagnostic activity logging method according to one embodiment of the subject application.

### DETAILED DESCRIPTION OF THE PREFERRED EMBODIMENT

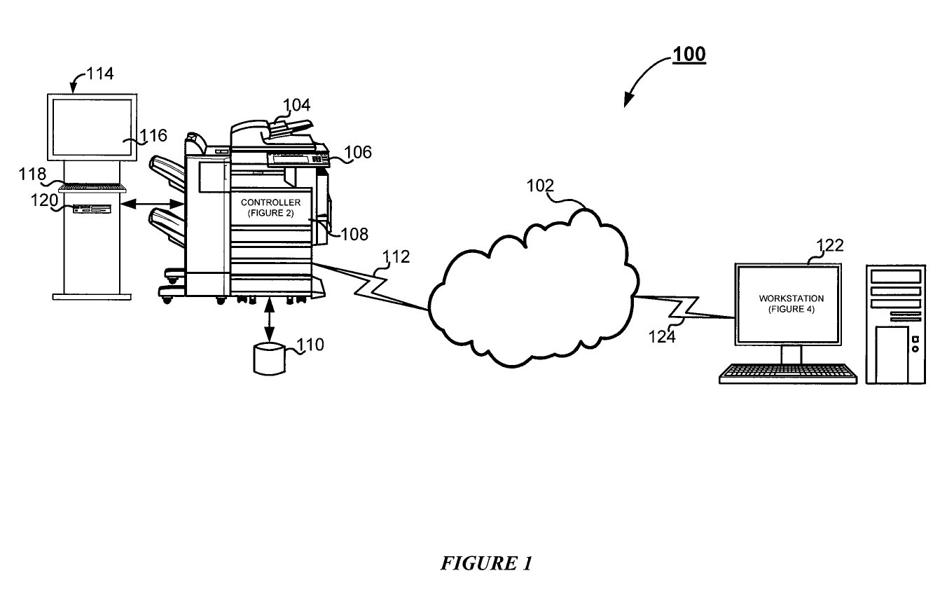

The subject application is directed to a system and method for user interface action logging. In particular, the subject application is directed to a system and method for the strategic capturing of user interface sessions to assist in diagnosing system errors. It will become apparent to those skilled in the art that the system and method described herein are suitably adapted to a plurality of varying electronic fields that employ user interface monitoring including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for user interface diagnostic activity logging in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 can include, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations can include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, or any suitable combination thereof, configured to interact with an associated user, a networked device, or the like.

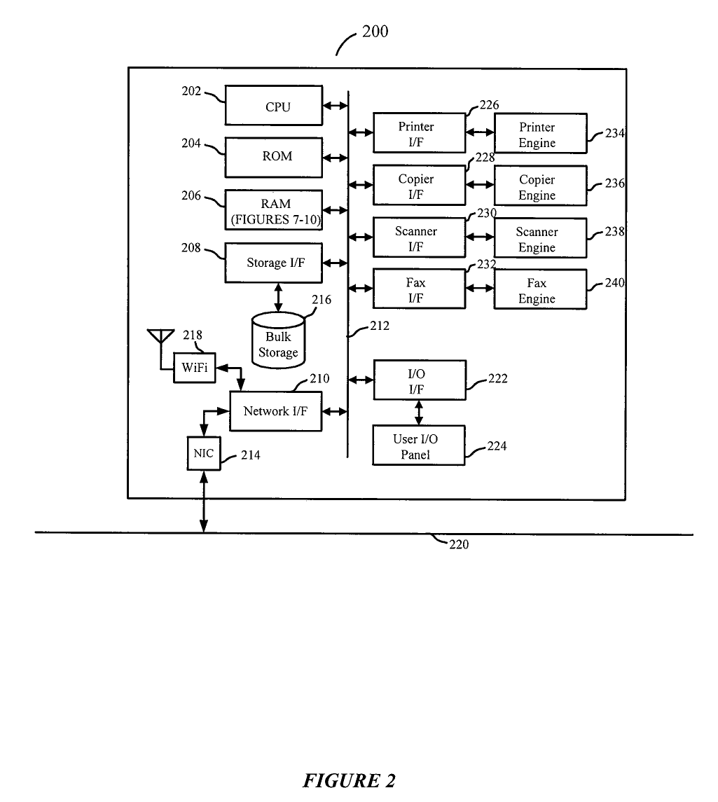

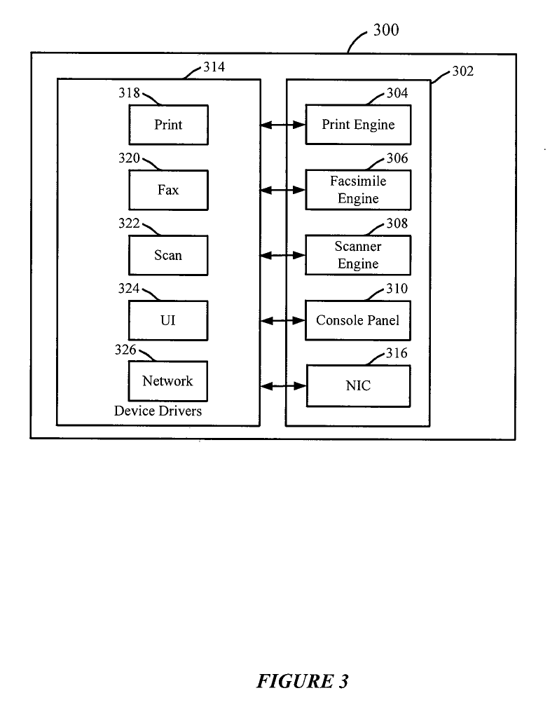

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; receive input from the associated user; and communicate the same to a backend component, such as the controller 108, as explained in greater detail below. Preferably, the document processing device 104 is communicatively coupled to the computer network 102 via a communications link 112. As will be understood by those skilled in the art, suitable communications links 112 include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

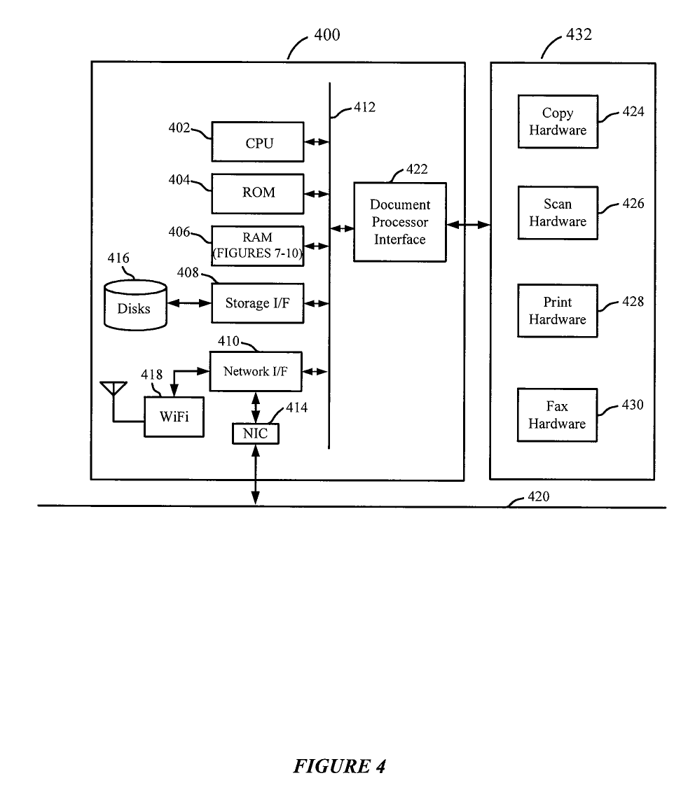

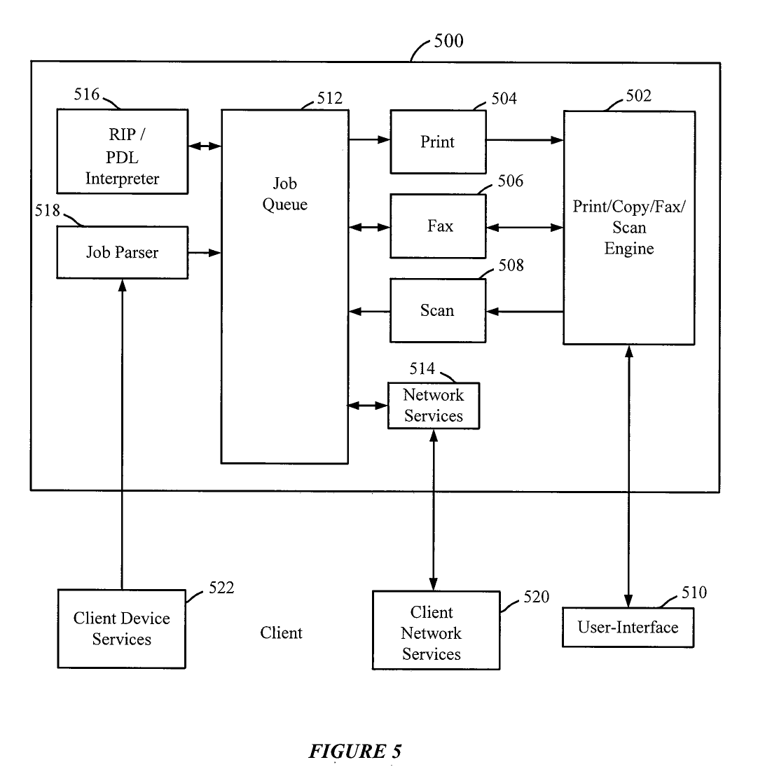

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for user interface diagnostic activity logging. The functioning of the controller 108 will be better understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

Illustrated in FIG. 1 is a kiosk 114 communicatively coupled to the document processing device 104 and, in effect, the computer network 102. It will be appreciated by those skilled in the art that the kiosk 114 is capable of being implemented as separate component of the document processing device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes a display 116 and user input device 118. As will be understood by those skilled in the art, the kiosk 114 is capable of implementing a combination user input device/display, such as a touch screen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120 coupled to the kiosk 114 and suitably adapted to receive and access myriad different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

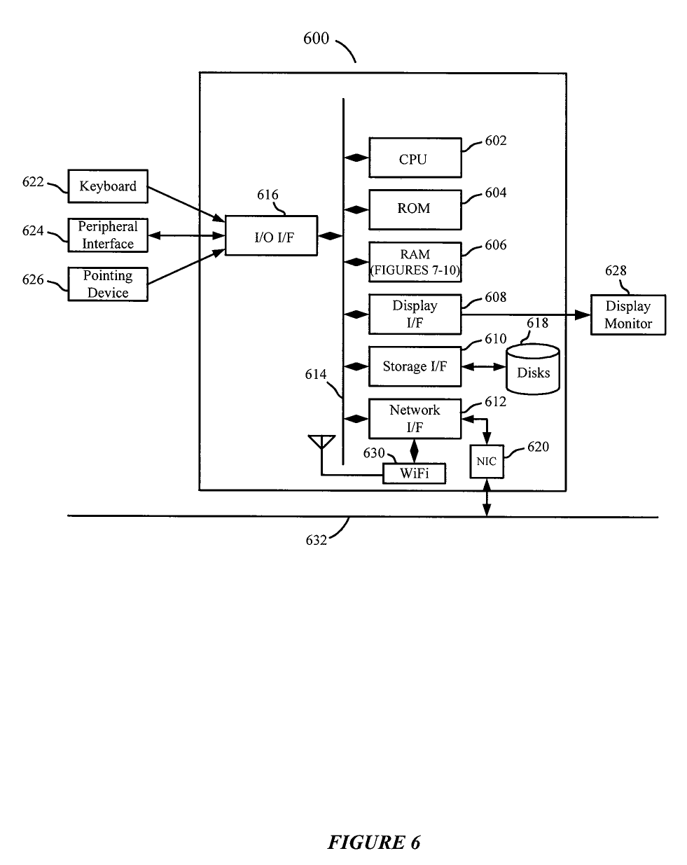

The system 100 illustrated in FIG. 1 further depicts an administrative device 122 in data communication with the computer network 102 via a communications link 124. It will be appreciated by those skilled in the art that the administrative device 122 is shown in FIG. 1 as a computer workstation for illustration purposes only. As will be understood by those skilled in the art, the administrative device 122 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 124 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative device 122 is suitably adapted to receive status data, job data, user interface data, and/or image data; perform color calculations and conversions; generate display data; generate output data; or the like to the document processing device 104 or any other similar device coupled to the computer network 102. The functioning of the administrative device 122 will be better understood in conjunction with the block diagrams illustrated in FIG. 6, explained in greater detail below.

Turning now to FIG. 2, illustrated is a representative architecture of a suitable device 200, shown in FIG. 1 as the document processing device 104, on which operations of the subject system 100 are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long term storage of data associated with the device 200. The storage interface 208 suitably uses bulk storage, such as any suitable addressable or serial storage such as a disk, optical, tape drive, or the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, Token-Ring, and the like, and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing device 104, for use in connection with the disclosed system 100. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with the input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via a driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long term storage of data associated with the controller 400. The storage interface 408 suitably uses bulk storage, such as any suitable addressable or serial storage such as a disk, optical, tape drive and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access the functionality controlled by the engine 502. Access is suitably enabled via an interface local to the controller or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 also is advantageously placed in data communication with an image processor 516. The image processor 516 is suitably a raster image process, page description language interpreter, or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative device 122, for use in connection with the subject system 100. A suitable workstation includes a processor unit 602, which is advantageously placed in data communication with read only memory 604, suitably non-volatile read only memory, volatile read only memory, or a combination thereof; random access memory 606; display interface 608; storage interface 610; and network interface 612. In a preferred embodiment, interface to the foregoing modules is suitably accomplished via a bus 614.

The read only memory 604 suitably includes firmware, such as static data or fixed instructions such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device, as will be appreciated by one of ordinary skill in the art.

The storage interface 610 suitably provides a mechanism for non-volatile, bulk, or long term storage of data or instructions in the workstation 600. The storage interface 610 suitably uses a storage mechanism, such as storage 618, suitably comprised of a disk, tape, CD, DVD, or other relatively higher-capacity addressable or serial storage medium.

The network interface 612 suitably communicates to at least one other network interface, shown as network interface 620, such as a network interface card, and wireless network interface 630, such as a WiFi wireless network card. It will be appreciated by one of ordinary skill in the art that a suitable network interface 612 is comprised of both physical and protocol layers and is suitably any wired system such as Ethernet, Token-Ring, or any other wide area or local area network communication system or wireless system, such as WiFi, WiMax, or any other suitable wireless network system, as will be appreciated by one of ordinary skill in the art. In the illustration, the network interface 620 is interconnected for data interchange via a physical network 632 suitably comprised of a local area network, wide area network, or a combination thereof.

An input/output interface 616 in data communication with the bus 614 is suitably connected with an input device 622 such as a keyboard or the like. The input/output interface 616 also suitably provides data output to a peripheral interface 624 such as a USB, universal serial bus output, SCSI, Firewire (IEEE 1394) output, or any other interface, as may be appropriate for a selected application. Finally, the input/output interface 616 is suitably in data communication with a pointing device interface 626 for connection with devices such as a mouse, light pen, touch screen, or the like.

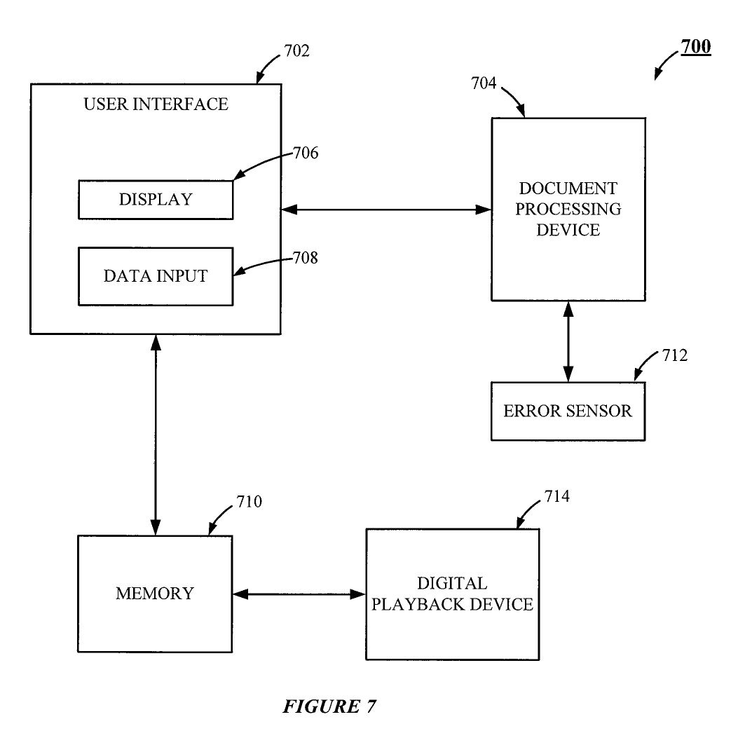

Turning now to FIG. 7, illustrated is a block diagram of a system 700 for user interface diagnostic activity logging in accordance with one embodiment of the subject application. The system 700 includes a user interface 702 associated with a document processing device 704. In accordance with one embodiment of the subject application, the user interface 702 includes a data input 708 and a display 706. Sequence data associated with a sequence of operations for each of a plurality of user sessions for control of the document processing device 704 via the data input 708 of the user interface 702 is stored in a memory 710. Pre-selected parameters associated with the acquisition of each sequence of operations also are stored in the memory 710.

The system 700 also includes an error sensor 712 associated with the document processing device 704, which monitors operations of the device 704. The error sensor 712 initiates a trigger upon the occurrence of an event, which prompts the capture of sequence data from the data input 708. The system 700 further includes a digital playback device 714 in data communication with the memory 710 for playing back the sequence of instructions stored in the memory 710.

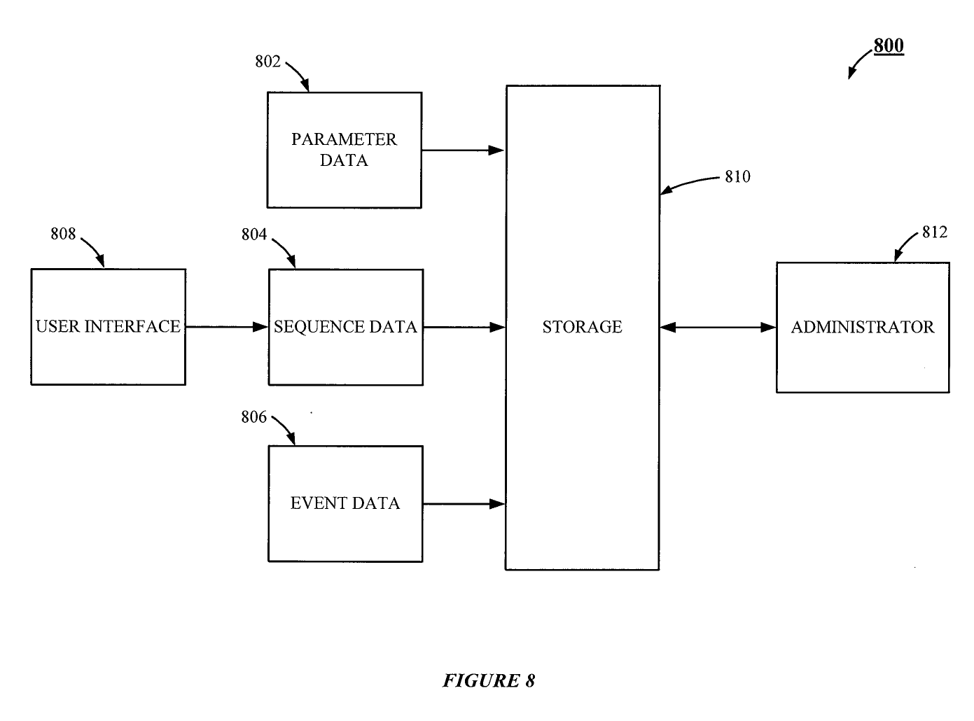

Referring now to FIG. 8, there is shown a functional diagram 800 of the system for user interface diagnostic activity logging in accordance with one embodiment of the subject application. Parameter data 802 is first acquired corresponding to selected data acquisition parameters and stored in an associated storage 810. Sequence data 804 then is acquired corresponding to instructions for control of an associated document processing device via the associated user interface 808. The sequence data 804 then is stored in the associated storage 810. Preferably, the sequence data 804 is acquired from the user interface 808 in accordance with the previously-received parameter data 802. Event data 806 then is acquired corresponding to the occurrence of a selected event by the document processing device and stored in the associated data storage 810. The stored sequence data 804 and event data 806 then is selectively communicated to an administrator 812 following the acquisition of the event data 806.

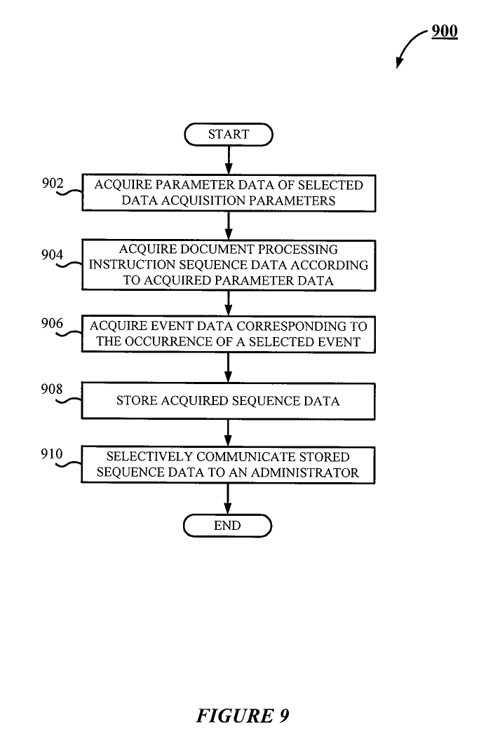

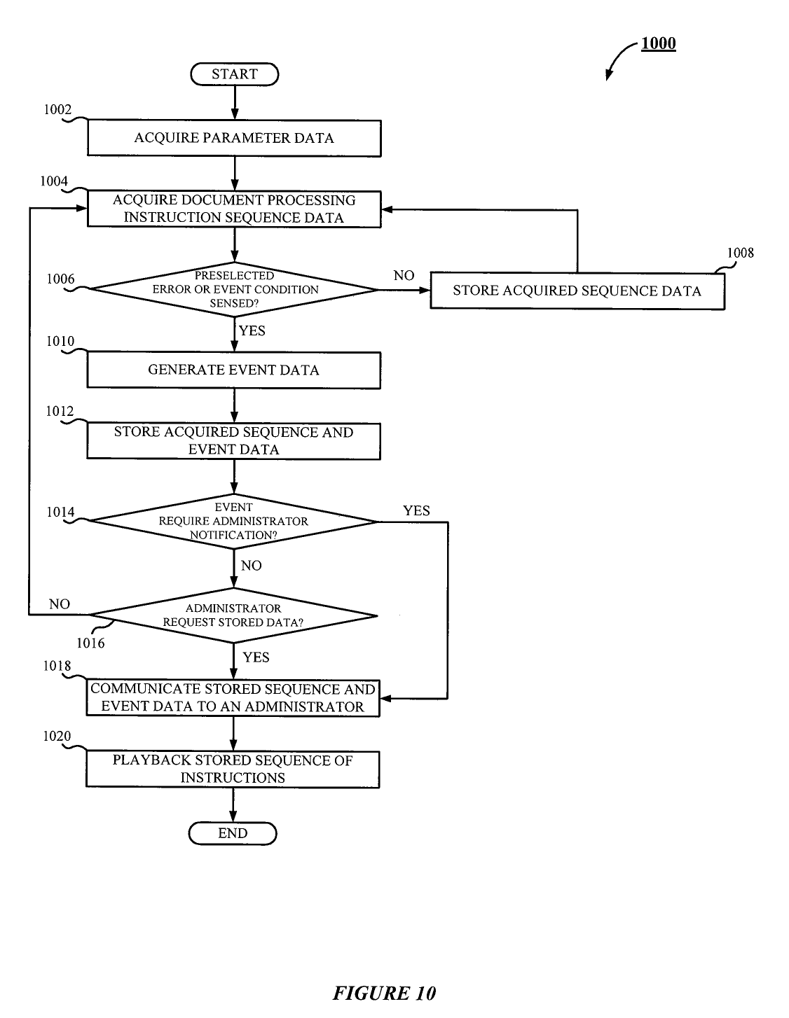

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for user interface diagnostic activity logging in accordance with one embodiment of the subject application. Beginning at step 902, parameter data corresponding to selected data acquisition parameters is acquired by the controller 108 or other suitable component associated with the document processing device 104. Sequence data is then acquired by the controller 108 at step 904 corresponding to instructions for the control of the document processing device 104 via the user interface 106, the kiosk 114, or other such interface device associated with the document processing device 104. In accordance with one embodiment of the subject application, the sequence data is acquired in accordance with the parameter data.

At step 906, the controller 108 or other suitable component associated with the document processing device 104 acquires event data corresponding to the occurrence of a selected event by the document processing device 104. The acquired sequence data then is stored in the data storage device 110 associated with the document processing device 104 at step 908. The stored sequence data then is selectively communicated at step 910 to the associated administrator 122 upon receipt of the event data. It will be appreciated by those skilled in the art that the administrator is capable of receiving such sequence data via the computer network 102 in the form of an electronic mail attachment, file transfer, SMS message, or the like.

Referring now to FIG. 10, there is shown a flowchart 1000 illustrating a method for user interface diagnostic activity logging in accordance with one embodiment of the subject application. The methodology of FIG. 10 begins at step 1002, whereupon parameter data is first acquired by the controller 108 or other suitable component associated with the document processing device 104 from the administrative device 122, an administrative user via physical or electronic interaction with the document processing device 104, or the like.

Following acquisition of the parameter data, a user associated with the document processing device 104 begins requesting a document processing operation via interactions with the user interface 106, the kiosk 114, or the like. The skilled artisan will appreciate that such interaction entails user navigation through a plurality of screens, menus, and selections, whereby the user provides document processing instructions to the controller 108 or other suitable component associated with the document processing device 104 for purposes of performing a desired document processing operation. At step 1004, the controller 108 or other suitable component associated with the document processing device 104 acquires sequence data corresponding to instructions for the control of the document processing device 104 via the user interface 106, the kiosk 114, or the like. Preferably, the sequence data is acquired in association with the received parameter data. It will be appreciated by those skilled in the art that the parameter data includes, for example and without limitation, a number of steps in the sequence of instructions, a data size associated with the sequence of instructions, and the like. Thus, the skilled artisan will appreciate that the acquired sequence data corresponds to the number of steps in the sequence of instructions, the data size associated with the sequence of instructions, or the like. According to one embodiment of the subject application, the acquired sequence data further includes, for example and without limitation, user activity tokens, screen navigations, model change notifications, controller command status, error messages, and the like.

A determination is then made by the controller 108 or other suitable component associated with the document processing device 104 at step 1006 as to whether a pre-selected error condition has been sensed. That is, the controller 108 analyzes the received instructions and the performance thereof to determine whether an error has occurred during the processing by the document processing device 104. When no error condition or other pre-selected event has occurred, flow proceeds to step 1008, whereupon the controller 108 or other suitable component associated with the document processing device 104 facilitates the storage of the acquired sequence data in the data storage 110. Thereafter, flow returns to step 1004 for acquisition of sequence data in accordance with the acquired parameter data for the next submitted document processing operation.

Upon a determination at step 1006 that a pre-selected error condition has been sensed or a pre-selected event has occurred, flow proceeds to step 1010, whereupon the controller 108 or other suitable component associated with the document processing device 104 generates event data corresponding to the detected error condition or pre-selected event. In accordance with one embodiment of the subject application, the event data includes, for example and without limitation, the type of error detected, any error messages generated, and other error-related data, as will be understood by those skilled in the art. The acquired sequence and generated event data is then stored in the data storage 110 associated with the document processing device 104 at step 1012.

A determination is then made at step 1014 as to whether the detected error condition or event requires that a notification be sent to a suitable administrator, e.g. the administrative device 122. The skilled artisan will appreciate that such a determination is capable of being made based upon the type of error that has occurred, e.g. the device 104 is inoperable, the error type meets a predetermined standard, an amount of time since a last communication to the administrator was made, or the like. When the controller 108 or other suitable component associated with the document processing device 104 determines that the sensed event requires notification of the administrator, flow proceeds to step 1018. At step 1018, the stored sequence and event data is communicated to the administrative device 122 via the computer network 102. In accordance with one embodiment of the subject application, the communication to the administrative device 122 is in a platform-independent format such as, for example and without limitation, extensible markup language, database, simple text file, or the like. The skilled artisan will appreciate that such communication is capable of being accomplished via electronic mail communication, file transfer, SMS messaging, or the like. At step 1020, the administrative device 122 plays back the stored sequence of instructions so as to replicate, diagnose, and correct the detected error condition.

Returning to step 1014, upon a determination that the event does not require administrator notification, flow progresses to step 1016. At step 1016, the controller 108 or other suitable component associated with the document processing device 104 determines whether a request has been received from the administrative terminal 122 requesting communication of stored data. When no such request has been received, flow returns to step 1004, whereupon the next set of instructions is received from an associated user via the user interface 106, the kiosk 114, or the like. When it is determined at step 1016 that the administrator has requested stored data, operations proceed to step 1018. At step 1018, the stored sequence and event data is communicated to the administrative device 122 via the computer network 102. As set forth above, the communication of such stored sequence and event data is preferably made in a platform-independent format including, for example and without limitation, extensible markup language, database, simple text file, or the like. It will be appreciated by those skilled in the art that such communication is capable of being accomplished via electronic mail communication, file transfer, SMS messaging, or the like. Following receipt by the administrative device 122 of the requested stored data, the administrative device 122 or other suitable electronic device plays back the stored sequence of instructions so as to replicate, diagnose, and correct the detected error condition at step 1020.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A user interface diagnostic activity logging system, comprising:
a user interface associated with a document processing device, the user interface including a data input and a display;
a memory, in which is stored sequence data associated with a sequence of operations for each of a plurality of user sessions for control of the document processing device via the data input of user interface; and
the memory, into which is further stored data corresponding to pre-selected parameters associated with acquisition of each sequence of operations stored in the memory.

2. The system of claim 1, further comprising an error sensor associated with operation of the document processing device and wherein the memory includes sequence data captured in accordance with a trigger initiated by the error sensor.

3. The system of claim 2, further comprising a digital playback device in data communication with the memory for playing back the sequence of instructions stored in the memory.

4. A user interface diagnostic activity logging method, comprising the steps of:
acquiring parameter data corresponding to selected data acquisition parameters;
acquiring sequence data corresponding to instructions for control of the document processing device via an associated user interface, which sequence is acquired in accordance with acquired parameter data;
acquiring event data corresponding to an occurrence of a selected event by the document processing device;
storing acquired sequence data in a storage; and
selectively communicating stored sequence data to an associated administrator upon receipt of event data.

5. The method of claim 4, further comprising the steps of:
sensing a pre-selected error condition of the document processing device; and
generating the event data in accordance with a sensed error condition.

6. The method of claim 5, wherein the parameter data includes at least one of a number of steps in the sequence of instructions and a data size associated with the sequence of instructions.

7. The method of claim 6, further comprising the step of playing back the sequence of instructions stored in the storage.

8. The method of claim 7, wherein the sequence of instructions includes instructions corresponding to at least one of user interface navigation, job control events, controller status, and component execution status.

9. A user interface diagnostic activity logging system, comprising:
means adapted for acquiring parameter data corresponding to selected data acquisition parameters;
user interface means adapted for controlling an associated document processing device;
means adapted for acquiring sequence data corresponding to instructions for control of the document processing device via the user interface, which sequence data is acquired in accordance with acquired parameter data;
means adapted for acquiring event data corresponding to an occurrence of a selected event by the document processing device;
storage means adapted for storing acquired sequence data; and
means adapted for selectively communicating stored sequence data to an associated administrator upon receipt of event data.

10. The system of claim 9, further comprising:
means adapted for sensing a pre-selected error condition of the document processing device; and
means adapted for generating the event data in accordance with a sensed error condition.

11. The system of claim 10, wherein the parameter data includes at least one of a number of steps in the sequence of instructions and a data size associated with the sequence of instructions.

12. The system of claim 11, further comprising playback means adapted for playing back the sequence of instructions stored in the storage means.

13. The system of claim 12, wherein the sequence of instructions includes instructions corresponding to at least one of user interface navigation, job control events, controller status, and component execution status.
